(19) United States
(12) Patent Application Publication
(10) Pub. No.: US 2008/0007236 A1
(43) Pub. Date: Jan. 10, 2008

(54) Power converter with segmented power module

(76) Inventor: Alan Elbanhawy, Hollister, CA (US)

Correspondence Address: SIDLEY AUSTIN LLP, 555 CALIFORNIA STREET, SUITE 2000, SAN FRANCISCO, CA, 94104-1715, US

(21) Appl. No.: 11/481,473

(22) Filed: Jul. 6, 2006

(51) Int. Cl. G05F 1/00

(52) U.S. Cl. 323/283

(57) ABSTRACT

According to an embodiment, a power converter system includes an output node at which an output voltage is provided. A segmented power module, coupled to the output node, has a plurality of segments. Each segment is implemented with a switch having a size which is different from the size of switch used to implement any other segment. Driver logic, coupled to the segmented power module, is operable to determine power dissipation in the power converter system, and to select at least one of the segments in the segmented power module in response to the determined power dissipation in order to optimize efficiency in the power converter system

### TECHNICAL FIELD OF INVENTION

The present invention relates to power conversion, and more particularly, to a power converter with segmented power module.

### BACKGROUND

Power converters are used to convert power from one form or magnitude into another. Various types of power converters include a buck (step-down) converter, a boost (step-up) converter, and a buck-boost converter. Many power converters employ one or more switches, such as metal-oxide-semiconductor field effect transistors (MOSFETs), having gates to which driving voltages are applied. The efficiency of some power converters (e.g., a synchronous buck converter) is related to conduction and dynamic loss mechanisms. Both of these loss mechanisms depend on the gate driver voltage at a specific current and switching frequency. According to previously developed techniques, power converters were set to operate most efficiently at a specified current level, which was typically the maximum current level expected in operation. In some electronic devices in which power converters are used (e.g., a notebook computer or handheld device), the electronic devices are run at low current for most of the time (e.g., in a “standby” mode). This is very inefficient for a power converter that is set to operate most efficiently at a high current level. It is desirable to provide a power converter which operates efficiently under a variety of conditions (e.g., both high and low current levels).

### SUMMARY

According to an embodiment of the present invention, a method comprises: providing a power converter with a plurality of segments, each segment implemented with a switch having a size which is different from the size of switch used to implement any other segment; determining a power dissipation in the power converter; and selecting one of the segments in response to the determined power dissipation in order to optimize efficiency in the power converter.

According to another embodiment of the present invention, a power converter system includes an output node at which an output voltage is provided. A segmented power module, coupled to the output node, has a plurality of segments. Each segment is implemented with a switch having a size which is different from the size of switch used to implement any other segment. Driver logic, coupled to the segmented power module, is operable to determine power dissipation in the power converter system, and to select at least one of the segments in the segmented power module in response to the determined power dissipation in order to optimize efficiency in the power converter system.

According to yet another embodiment of the present invention, a power converter system includes an output node at which an output voltage is provided. A segmented power module, coupled to the output node, has a first group of segments and a second group of segments. The first group of segments is coupled to the second group of segments in a half-bridge arrangement. Each segment in the first group and the second group is implemented with a respective switch. Driver logic, coupled to the segmented power module, is operable to determine power dissipation in the power converter system, and to select at least one of the segments in the segmented power module in response to the determined power dissipation in order to optimize efficiency in the power converter system

Important technical advantages of the present invention are readily apparent to one skilled in the art from the following figures, descriptions, and claims.

### BRIEF DESCRIPTION OF DRAWINGS

For a more complete understanding of the present invention and for further features and advantages, reference is now made to the following description taken in conjunction with the accompanying drawings.

FIG. 1 is a schematic diagram in partial block form of a power converter with segmented power module, according to an embodiment of the invention.

FIGS. 2A and 2b are schematic diagrams in partial block form of exemplary implementations for a power converter with segmented power module, according to embodiments of the invention.

FIG. 3 is a diagram illustrating the efficiency of various segments which may be include in a segmented power module, according to an embodiment of the invention.

FIG. 4 is a diagram comparing the efficiency of a power converter according to embodiments of the present invention with the efficiency of a power converter according to previously developed techniques.

FIG. 5 is another diagram comparing the efficiency of a power converter according to embodiments of the present invention with the efficiency of a power converter according to previously developed techniques.

### DETAILED DESCRIPTION

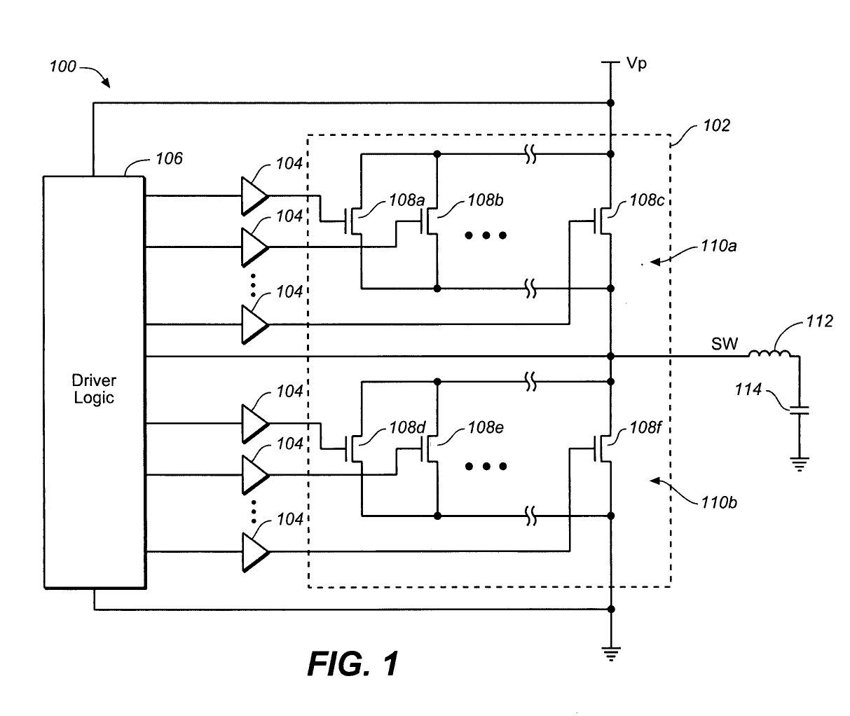

Embodiments of the present invention and their advantages are best understood by referring to FIGS. 1 through 5 of the drawings. Like numerals are used for like and corresponding parts of the various drawings.

According to embodiments of the present invention, systems and methods are provided for a power converter which may operate efficiently at a variety of current levels or other operating conditions. In some embodiments, this can be accomplished by providing a power converter with a segmented power module in which different segments can be chosen or selected to optimize or increase the efficiency of operation of the power converter under the various conditions. Each segment may comprise a switch or transistor (e.g., metal-oxide-semiconductor field effect transistor (MOSFET)). In some embodiments, the selection of segments can be accomplished by using a look-up table which specifies certain segments to turn on in response to the power dissipation in the power converter during operation. Power dissipation in the converter can be measured or determined, for example, by measuring the voltage drop across the switch in a currently selected segment and deriving power dissipation using the on-resistance value across its source and drain (Rdson). In some embodiments, the power converter can be a buck (step-down) converter, boost (step-up) converter, buck-boost converter, flyback converter, or other converter which converts a direct current (DC) voltage at one magnitude into a direct current (DC) voltage at another magnitude (lower or higher).

FIG. 1 is a schematic diagram in partial block form of a power converter 100, according to an embodiment of the present invention. In this embodiment, power converter 100 can be a buck (step-down) which converts a voltage at a higher magnitude (e.g., 19V) into a voltage at a lower magnitude (e.g., 1.3V). Power converter 100 can be incorporated in or used with an electronic device, such as, for example, a notebook computer, handheld, or other portable device. As shown, power converter 100 includes a segmented power module 102, drivers 104, and driver logic 106. The output of power converter 100 appears at a switching (SW) node.

Power converter 100 may also include or be coupled to an inductor 112 and a capacitor 114. As used herein, the terms “coupled” or “connected,” or any variant thereof, covers any coupling or connection, either direct or indirect, between two or more elements. Inductor 112 may carry an alternating current (AC) component and a DC component. The AC component of inductor 112 ramps up and down during operation of the power converter 100; the DC component is stable.

Segmented power module 102 of power converter 100 comprises a number of segments 108 (e.g., 108a, 108b, 108c, 108d, 108e, and 108f). Any suitable number n of segments 108 can be provided, where n can be, for example, 2, 3, 4, or 5. As shown, one group 110a of segments 108 may be provided for a “high-side” of the power converter 100, and another group 110b of segments 108 may be provided for a “low-side” of the power converter 100. The high-side group 110a of segments 108 is coupled between a voltage source Vp and the SW output node; the low-side group 110b of segments 108 is coupled between the SW output node and ground. Such an arrangement with high-side and low-side is known as a half-bridge or “totem pole” arrangement. In other embodiments, groups of segments 108 can be connected in other arrangements, such as, for example, arrangements for flyback converter, boost converter, buck-boost converters, or other DC-to-DC converters used in mobile and handheld devices.

Each segment 108 is implemented with a switch, such as, for example, a metal-oxide-semiconductor field effect transistor (MOSFET), an IGBT, a MOS-gated thyristor, or other suitable power device. The switches (in each group) are connected in parallel between two nodes (i.e., either Vp and the SW output node, or the SW output node and ground). Each switch has a gate to which driving voltage may be applied to turn the switch on or off. In one embodiment, the switches in the high-side group 110a can be high-performance switches (i.e., having relatively fast switching times, but also high Rdson), while the switches in the low-side group 110b may be more efficient switches (i.e., having low Rdson).

When one or more switches in the high-side group 110a of segmented power module 102 are turned on, the power converter 100 ramps up the inductor current of inductor 112 and charges up capacitor 114. When one or more switches in low-side group 110b are turned on, the power converter 100 ramps down the current of inductor 112 and discharges capacitor 114. The switches in the groups 110a, 110b can be driven to alternatingly conduct. That is, none of the switches in high-side group 110a are turned on simultaneously with any of the switches in low-side group 110b, and vice versa. Rather, when any switch is turned on and conducting in the high-side group 110a, every switch in the low-side group 110b is turned off; and when any switch in the low-side group 110b is turned on and conducting, every switch in the high-side group 110a is turned off.

The switches for the various segments 108 (in a group 110) can be implemented in different sizes. For example, the size of the switch for segment 108b can be twice that of switch for segment 108a, and the size of the switch for segment 108c can be four times that of switch for segment 108a. Different size switches have different characteristics. For example, a larger size switch has lower on-resistance across its source and drain (Rdson). Thus, larger size switches are advantageous to reduce conduction losses, which are directly proportional to Rdson. A smaller size switch has lower gate charge capacitance (Qg), which is the capacitance that must be overcome to turn a switch on and off. As such, smaller size switches are advantageous to reduce gate capacitance switching losses, which are directly proportional to Qg. It should be understood that any selection of sizes for the switches can be used consistent with the teachings described herein.

One or more segments 108 (in a group 110) can be selected—i.e., the respective switches turned on—depending on the operating conditions of power converter 100. In particular, different size switches may be turned on at different points of operation in order to minimize the power losses which may occur in the power converter 100, thereby optimizing or providing improved efficiency for power converter 100.

Driver logic 106 and drivers 104 are connected to the segments 108 of the segmented power module 102. Driver logic 106 outputs a number of control signals for selecting corresponding segments 108 in the segmented power module 102. In one embodiment, each control signal may cause a respective driver 104 to drive the switch corresponding to the respective segment.

Driver logic 106 can be implemented as a digital controller (e.g., programmable logic array), an analog controller, or combination thereof, for performing one or more of the functions described herein. In some embodiments, driver logic 106 may have one or more inputs for sensing or receiving information to derive or calculate one or more operating conditions of the power converter 100 (e.g., voltage drop across a group 110, load current, power dissipation, etc.), so that driver logic 106 may output control signals in response thereto. For example, as shown, driver logic 106 is connected to the Vp voltage, the SW output node, and ground, and as such, has input for the voltage drop across group 110a (i.e., the voltage difference between Vp and the SW output node) and for the voltage drop across group 110b (i.e., the voltage difference between the SW output node and ground). Driver logic 106 may also keep track of or know which segments 108 are turned on or selected at a given moment of operation.

In some embodiments, driver logic 106 may comprise a look-up table or other logic (not expressly shown) which can be used to adjust the control signals for selecting segments 108 in the segmented power module 102. The look-up table may comprise a number of entries that specify which segment(s) 108 should be selected based upon power dissipation in the power converter 100, such as, for example, the power dissipated in the switches of segmented power module 102. Such power dissipation can be directly proportional to the on-resistance (Rdson) of a switch. In one embodiment, for example, if the Rdson of the switch of each segment 108 is known, and the driver logic 106 knows which switch or switches are on at a particular moment, then the power dissipation in the converter 100 can be determined or calculated by taking a measurement of voltage across or current flowing through those switch(es). That is, P=V²/R=I²R, where P is power, V is the voltage across the switch, I is the current flowing through the switch, and R is the Rdson of the switch. The look-up table in driver logic 106 may map which segment 108 to turn on for a given power dissipation for converter 100 during various points of operation.

In one embodiment, driver circuitry is provided to drive the segments 108 with control signals having voltages which are variable, such as, for example, proportional to the load current or power dissipation. This can provide a further improvement in efficiency for power converter 100. Circuitry and methods for implementing such technique for variable gate driver voltage is described in pending U.S. application Ser. No. 11/006,345, entitled “Current Controlled Gate Driver for Power Switches,” filed on Dec. 7, 2004, which is incorporated by reference herein in its entirety.

In some embodiments, segmented power module 102, drivers 104, and driver logic 106 of power converter 100 can be implemented on a single or multiple semiconductor dies (commonly referred to as a “chip”) or discrete components. Each die is a monolithic structure formed from, for example, silicon or other suitable material. For implementations using multiple dies or components, the dies and components can be assembled on a printed circuit board (PCB) having various traces for conveying signals therebetween. In one multiple-die implementation, the segments 108 of the high-side group 110a are provided on a first die, the segments 108 of the low-side group 110b are provided on a second die, and the driver logic 106 and drivers 104 are provided on a third die.

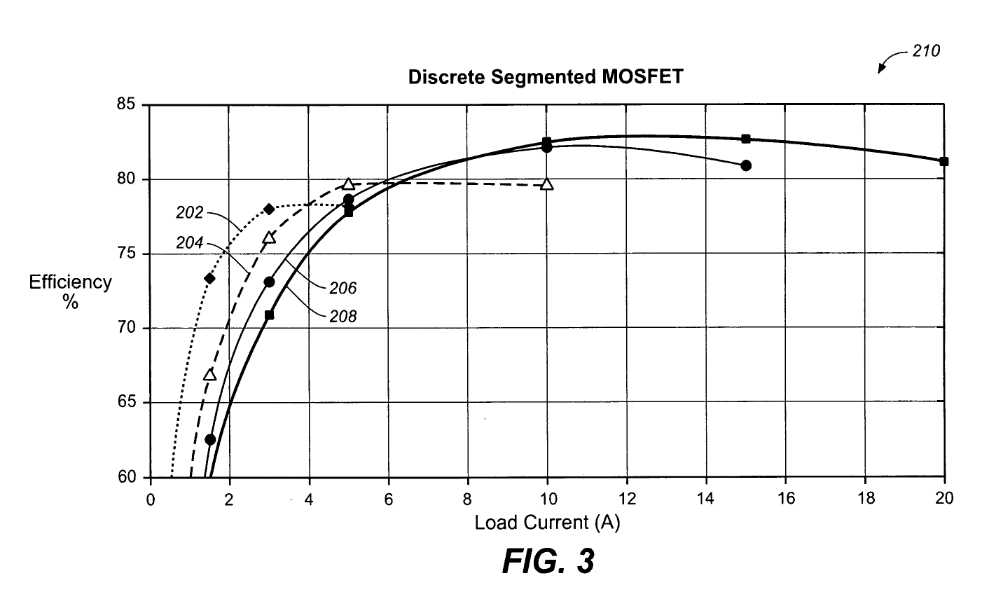

By providing power converter 100 with a segmented power module 102 implemented with a plurality of switches of varying sizes, different switches can be selected at different points of operation to optimize the efficiency of the power converter 100. This is shown in FIG. 3, which is a diagram 210 having a number of curves 202, 204, 206, and 208 representing the efficiency achieved with respective segments as a function of load current in power converter 100. Curve 202 corresponds to the smallest switch in the segmented power module 102, curve 204 corresponds to the next smallest switch in module 102, and so on, with curve 208 corresponding to the largest switch in module 102. As seen in FIG. 3, the smallest switch provides the greatest efficiency at low load current, the largest switch provides the greatest efficiency at high load current, and for everything in between, one or more of the other switches provides the greatest efficiency.

Referring now to FIGS. 1 and 3, in a method of operation for power converter 100, a first segment 108 of the segmented power module 102 is initially selected to provide the greatest efficiency when the load current in power converter 100 is low. Driver logic 106 receives information that it uses to determine the power dissipation in power converter 100, such as, for example, the voltage drop from Vp to the SW node, or the voltage drop from the SW node to ground. As load current increases, and the power dissipation in power converter 100 changes, the driver logic 106 determines the power dissipation and may output signals in response for selecting another segment 108 (e.g., implemented with a larger size switch) in order to optimize efficiency under the those operating conditions. As the power dissipation continues to change, the driver logic 106 determines the power dissipation and outputs signals for selecting other segments 108 to continuously optimize efficiency in the power converter 100. In general, any combination of segments 108 in segmented power module 102 can be selected in order to increase or optimize efficiency. Power converter 100 thus provides high efficiency in a broad current range (from low current to high current). This is especially important for portable or handheld device which may operate at low currents (in standby mode) for most of the time and which may operate at full load current for only a small amount of time (e.g., 5%-15%). As such, power converter 100 may extend battery life for portable or handheld devices.

As described herein, the selection of segments 108 (switches) can be based on power dissipation. This may provide an advantage over previously developed systems in which segments (implemented with switches of varying sizes) are selected based on load current. In particular, when only load current is used as the basis of segment selection, then a circuit designer is constrained or restricted to using switches (e.g., MOSFETs) which are matched for particular current ranges. By using power dissipation as the basis of selecting segments, a circuit designer is given more freedom (i.e., less restricted) in choosing switches for implementing each segment.

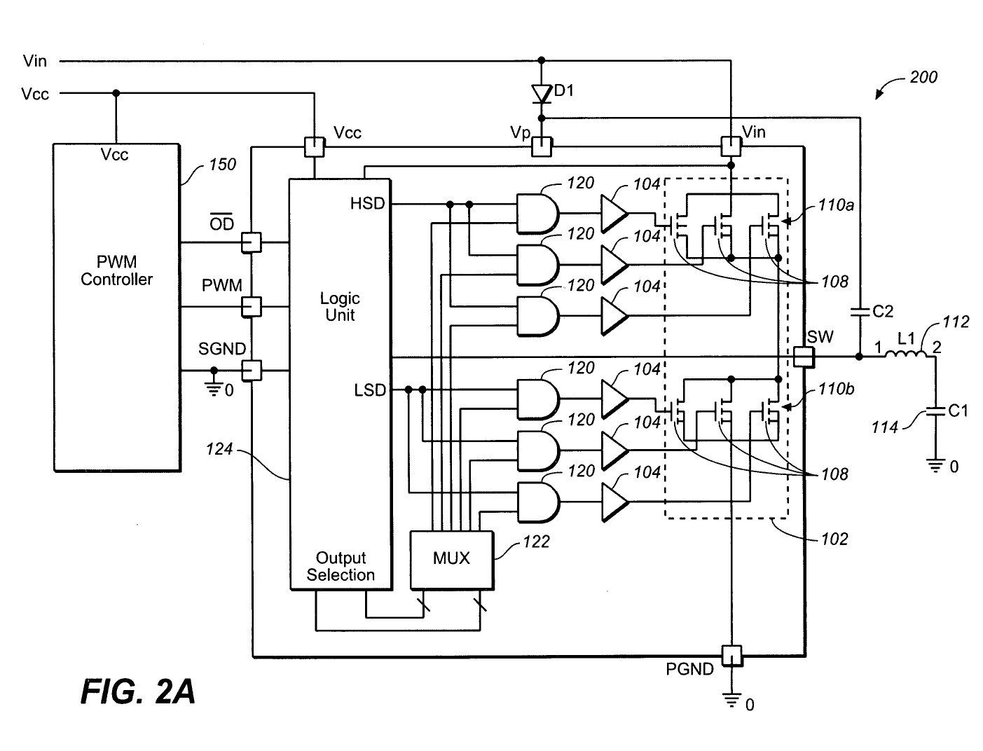

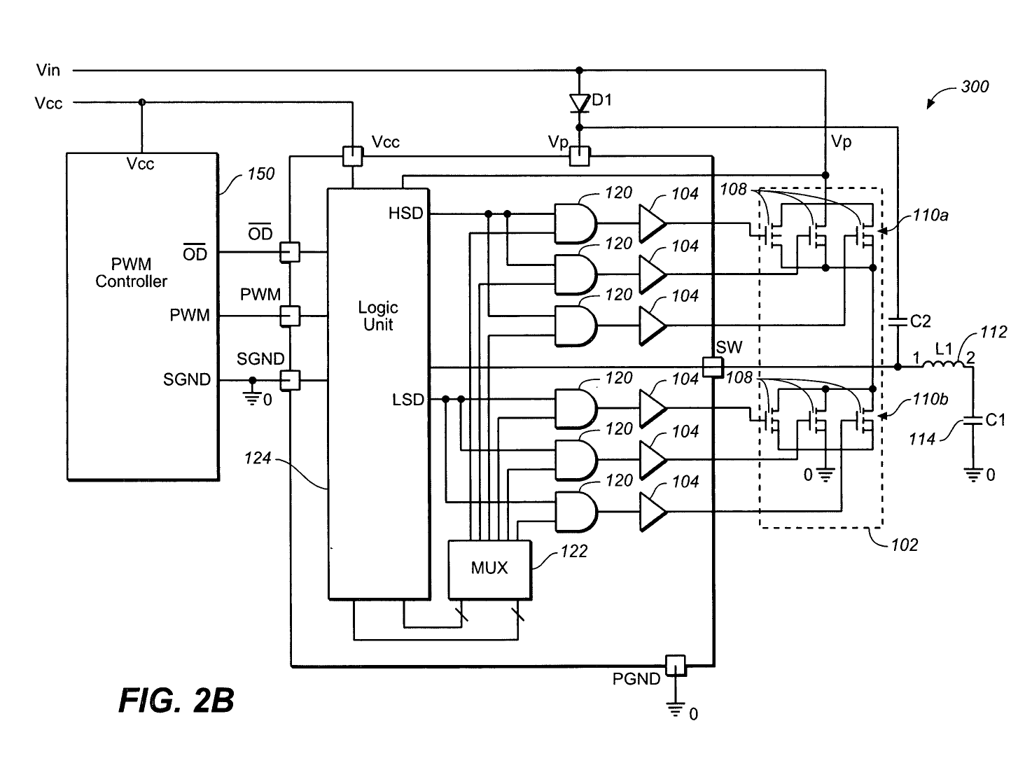

FIGS. 2A and 2B are schematic diagrams in partial block form of exemplary implementations 200 and 300 for a power converter, according to embodiments of the invention. As shown, each of these power converter implementations 200 and 300 may include segmented power module 102, drivers 104, AND gates 120, multiplexer (MUX) 122, and logic unit 124. In power converter implementation 200 shown in FIG. 2A, all of the components can be provided on a single semiconductor die or chip. In power converter implementation 300 shown in FIG. 2B, drivers 104, AND gates 120, multiplexer (MUX) 122, and logic unit 124 are provided on a single die or chip, and segmented power module 102 is implemented separately (for example, as discrete devices).

Power converter implementations 200 and 300 may include or be connected to a pulse width modulation (PWM) controller 150 which supports or provides PWM control for the power converter. PWM controller 150 outputs signals for fault (OD), pulse width modulation (PWM), and signal ground (SGND) to logic unit 124. As shown, the PWM controller 150 may be implemented on a separate die or chip, but in other embodiments, the PWM controller 150 may be provided on the same chip as one or more of the other components of power converter implementations 200 and 300.

The segmented power module 102 in each of the implementations 200 and 300 includes a first group 110a of segments 108 for a high-side of the power converter implementation and a second group 110b of segments 108 for a low-side. The high-side group 110a of segments 108 is coupled between a voltage source Vp and a node SW; the low-side group 110b of segments 108 is coupled between the node SW and ground.

Each of the high-side and low-side groups 110a, 110b includes three segments 108. Each segment 108 is implemented with a respective switch (e.g., MOSFET). The switches in each group 110 can vary in size, from smallest to largest. Smaller size switches provide for lower gate capacitance switching losses. Larger size switches provide for lower conduction losses. The three switches in each group 110a, 110b can be turned on or off in any combination, thus providing seven alternatives for switching. The segments 108 in each group 110 may be selected (i.e., the respective switches turned on) in order to optimize or increase efficiency of the power converter implementation.

Drivers 104 provide drive signals to the gates of the switches in segmented power module 102. Logic unit 124, multiplexer (MUX) 122, and AND gates 120 implement logic for controlling the driving of the switches. These components output control signals to the drivers 104.

Logic unit 124 may receive the OD, PWM, and SGND signals from PWM controller 150. Logic unit 124 may also receive information which it can use to calculate the power dissipation in the power converter implementation, such as, for example, the power dissipated in the switches of the segmented power module 102 (which can be related to conduction losses which are proportional to the on-resistance (Rdson) of each switch). For this, logic unit 124 is connected to the SW node. In response to the received information, logic unit 124 outputs signals to multiplexer (MUX) 122 and AND gates 120 for selecting various segments 108 in each of the high-side and low-side groups 110a, 110b of segments 108. Logic unit 124 may keep track of or know which segments 108 are turned on or selected at a given moment of operation. In some embodiments, logic unit 124 may have a look-up table comprising a number of entries that specify which segment(s) 108 should be selected based upon power dissipation in the power converter implementation 200 or 300.

Multiplexer 122 receives control signals from logic unit 124. These control signals can be used to select individual segments 108 (switches) in the segmented power module 102. In operation, multiplexer 122 allows some of the selection signals to pass through the AND gates 120 and prevents other selection signals from being provided to the driver 104.

AND gates 120 receive control signals from each of logic unit 124 and multiplexer 122. Some of the AND gates 120 (e.g., half) are associated with or provided for the high-side, and the other AND gates 120 (e.g., the other half) are associated with or provided for the low-side. The AND gates 120 for the high-side may all receive the same signal from the logic unit 124, such signal for selecting the high-side. The AND gates 120 for the low-side may likewise receive the same signal from the logic unit 124, with this signal selecting the low-side. Each AND gate receives a separate signal from multiplexer 122, which can be used to select an individual segment in the segmented power module 102. Each AND gate 120 performs an AND operation on the signals it receives from logic unit 124 and multiplexer 122, and if these control signals have the appropriate values, then the AND gate 120 will output a signal to cause a respective driver 104 to drive an associated switch.

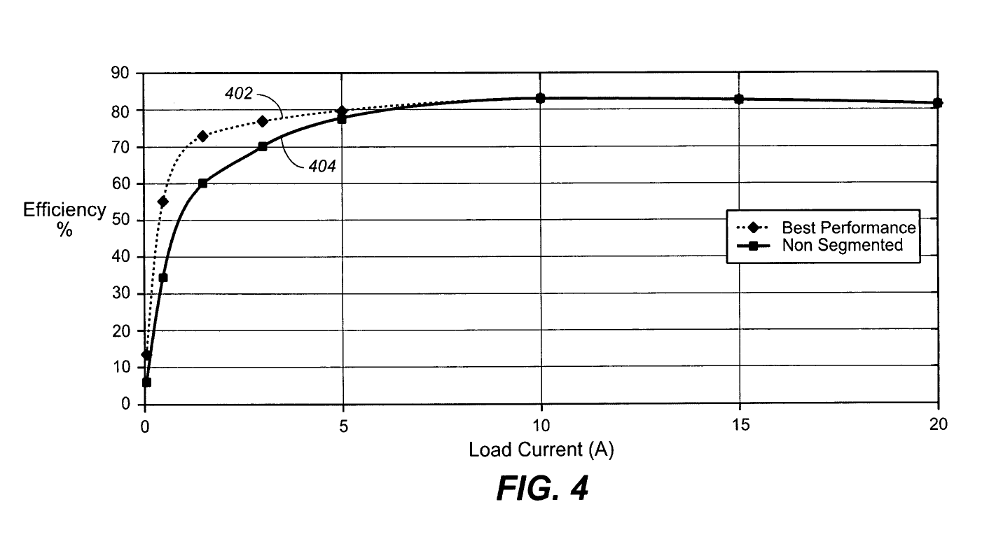

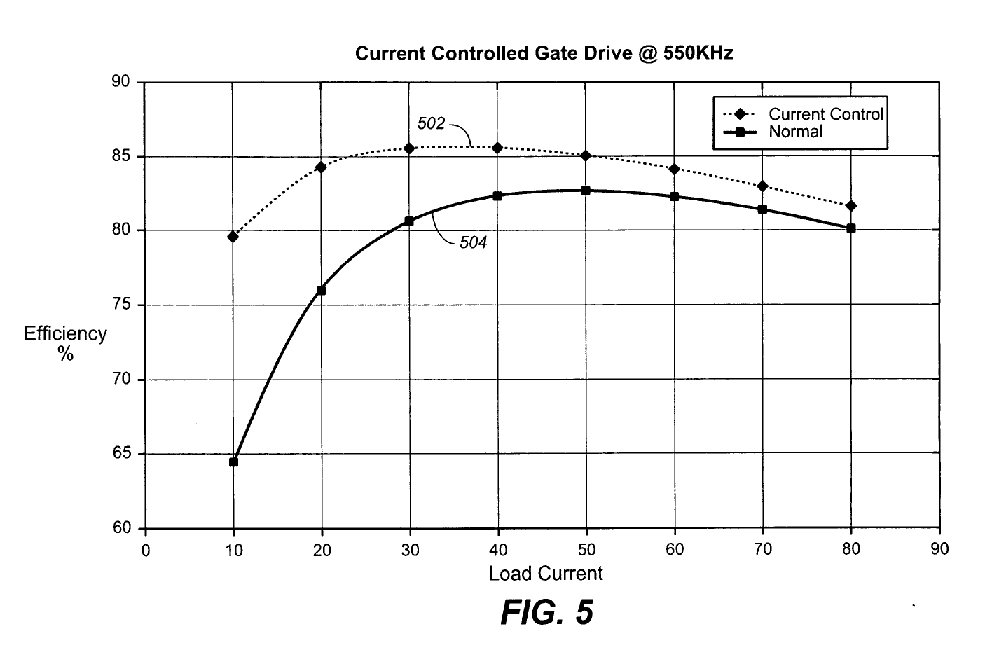

FIGS. 4 and 5 are diagrams 400 and 500 comparing the efficiency of a power converter according to embodiments of the present invention with the efficiency of a power converter according to previously developed techniques.

Referring to FIG. 4, curve 402 represents the efficiency of a power converter having a segmented power module 102 according to embodiments of the present invention over a range of currents, and curve 404 represents the efficiency of a power converter according to previously developed techniques over the same range of currents. As shown in FIG. 4, the embodiments of the present invention can achieve an almost flat efficiency curve (e.g., for buck or buck-derived converters) at any power or current range from very low load currents (e.g., less than 5 amps) to full current (e.g., over 20 amps). That is, the efficiency of a power converter according to some embodiments of the present invention is consistently high over a broad range of currents). This is in contrast to power converters according to previously developed designs which have significantly lower efficiency at lower current levels. Thus, for example, referring to FIG. 4, at 1 amp of load current the power converter with segmented power module provides an improvement of 20% in efficiency versus previous designs which do not have segmented switches. Likewise, at 2 amps of load current, the power converter with segmented power module provides an 13% improvement in efficiency versus previous designs. Thus, embodiments of the present invention resolve or address the typically poor performance of previous designs having efficiencies in the range of 20% to 50% for low current operation in notebooks, handheld, or other portable devices. As such, embodiments of the present invention can extend the battery life of such devices.

As described herein, in one embodiment, driver circuitry may be provided to drive the segments 108 with control signals having voltages which are proportional to the load current, which can provide a further improvement in efficiency for a power converter. FIG. 5 is diagram which compares the efficiency of a power converter implementing such current-controlled gate drive technique with the efficiency of a power converter according to previously developed techniques. Referring to FIG. 5, curve 502 represents the efficiency of a power converter with current-controlled gate drive over a range of currents, and curve 504 represents the efficiency of a power converter according to previously developed techniques over the same range of currents. As shown, the power converter implementing the current-controlled gate drive technique provides greater efficiency over the entire range of currents.

Although the present invention and its advantages have been described in detail, it should be understood that various changes, substitutions, and alterations can be made therein without departing from the spirit and scope of the invention as defined by the appended claims. That is, the discussion included in this application is intended to serve as a basic description. It should be understood that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Neither the description nor the terminology is intended to limit the scope of the claims.

What is claimed is:

1. A method comprising:
providing a power converter with a plurality of segments, each segment implemented with a switch having a size which is different from the size of switch used to implement any other segment;
determining a power dissipation in the power converter; and
selecting one of the segments in response to the determined power dissipation in order to optimize efficiency in the power converter.

2. The method of claim 1, wherein selecting comprises using a lookup table.

3. The method of claim 2, wherein the lookup table comprises a plurality of entries, each entry specifying a segment to be selected based upon a respective amount of power dissipation in the power converter.

4. The method of claim 1, wherein selecting comprises using a digital controller.

5. The method of claim 1 comprising providing a drive signal to the selected segment.

6. The method of claim 5, wherein the drive signal has a variable voltage.

7. The method of claim 6, wherein the voltage of the drive signal is proportional to a load current of the power converter.

8. The method of claim 1, wherein each switch is driven with a control signal having a variable voltage.

9. The method of claim 1, wherein each switch is driven with a control signal having a voltage which is proportional to a load current of the power converter.

10. The method of claim 1, wherein each switch comprises a MOSFET.

11. The method of claim 1, wherein at least a portion of the power converter is implemented on an integrated circuit device.

12. A power converter system comprising:
an output node at which an output voltage is provided;
a segmented power module coupled to the output node, the segmented power module having a plurality of segments, each segment implemented with a switch having a size which is different from the size of switch used to implement any other segment; and
driver logic coupled to the segmented power module, the driver logic operable to determine power dissipation in the power converter system, the driver logic operable to select at least one of the segments in the segmented power module in response to the determined power dissipation in order to optimize efficiency in the power converter system.

13. The power converter system of claim 12, wherein the driver logic comprises a look-up table.

14. The power converter system of claim 13, wherein the lookup table comprises a plurality of entries, each entry specifying a segment to be selected based upon a respective amount of power dissipation in the power converter system.

15. The power converter system of claim 12, wherein the driver logic comprises a digital controller.

16. The power converter system of claim 12, wherein at least a portion of the power converter system is implemented on an integrated circuit device.

17. The power converter system of claim 12, wherein the segmented power module is implemented on a first integrated circuit chip and the driver logic is implemented on a second integrated circuit chip.

18. The power converter system of claim 12, wherein each switch comprises a MOSFET.

19. The power converter system of claim 12, wherein the driver logic is operable to provide a drive signal to the selected segment.

20. The power converter system of claim 19, wherein the drive signal has a variable voltage.

21. The power converter system of claim 20, wherein the voltage of the drive signal is proportional to a load current of the power converter system.

22. The power converter system of claim 12, wherein each switch is driven with a control signal having a variable voltage.

23. The power converter system of claim 12, wherein each switch is driven with a control signal having a voltage which is proportional to a load current of the power converter.

24. A power converter system comprising:
an output node at which an output voltage is provided;
a segmented power module coupled to the output node, the segmented power module having a first group of segments and a second group of segments, the first group of segments coupled to the second group of segments in a half-bridge arrangement, each segment in the first group and the second group being implemented with a respective switch; and
driver logic coupled to the segmented power module, the driver logic operable to determine power dissipation in the power converter system, the driver logic operable to select at least one of the segments in the segmented power module in response to the determined power dissipation in order to optimize efficiency in the power converter system.

25. The power converter system of claim 24, wherein the driver logic comprises a look-up table.

26. The power converter system of claim 25, wherein the lookup table comprises a plurality of entries, each entry specifying a segment to be selected based upon a respective amount of power dissipation in the power converter system.

27. The power converter system of claim 24, wherein the driver logic comprises a digital controller.

28. The power converter system of claim 27, wherein at least a portion of the power converter system is implemented on an integrated circuit device.

29. The power converter system of claim 27, wherein the segmented power module is implemented on a first integrated circuit chip and the driver logic is implemented on a second integrated circuit chip.

30. The power converter system of claim 24, wherein the driver logic is operable to provide a drive signal to the selected segment.

31. The power converter system of claim 30, wherein the drive signal has a variable voltage.

32. The power converter system of claim 31, wherein the voltage of the drive signal is proportional to a load current of the power converter system.

33. The power converter system of claim 24, wherein each switch is driven with a control signal having a variable voltage.

34. The power converter system of claim 24, wherein each segment in the first group is implemented with a switch having a size which is different from the size of switch used to implement any other segment in the first group, and wherein each segment in the second group is implemented with a switch having a size which is different from the size of switch used to implement any other segment in the second group.
